(19) United States
(12) Patent Application Publication
(10) Pub. No.: US 2025/0181297 A1
(43) Pub. Date: Jun. 5, 2025

(54) System and Method for Dynamically Customizing Office Spaces

(71) Applicant: Christopher Woods, Nashville, TN (US)

(72) Inventor: Christopher Woods, Nashville, TN (US)

(21) Appl. No.: 18/964,063

(22) Filed: Nov. 29, 2024

Related U.S. Application Data
(60) Provisional application No. 63/604,302, filed on Nov. 30, 2023.

(51) Int. Cl. G06F 3/14; G06F 3/147

(52) U.S. Cl. CPC G06F 3/1423; G06F 3/147

(57) ABSTRACT

A virtual office space customization system is disclosed. The system operates via a software application installed on a computing device, such as a laptop, which communicates with a docking station. The docking station serves as a connectivity hub and links the computing device to a plurality of digital display panels, which can be LCD panels either permanently or detachably mounted on the walls of the office space. The software enables users to personalize their indoor environment by displaying content such as natural scenery, personal avatars, or work-related information on the display panels according to their preferences and profiles stored in cloud storage. The software enables users to select their profile and provides customization to the display settings of the display panels.

### CROSS-REFERENCE TO RELATED APPLICATION

The present application claims priority to, and the benefit of, U.S. Provisional Application No. 63/604,302, which was filed on Nov. 30, 2023, and is incorporated herein by reference in its entirety.

### FIELD OF THE INVENTION

The present invention generally relates to the field of indoor space customization. More specifically, the present invention relates to a novel system and method for enhancing personal and shared indoor spaces, particularly office environments, using customizable digital displays. The system includes a software application installed on a computing device, a docking station, and a plurality of digital displays. Images selected on the software application are dynamically displayed on the digital displays, thereby dynamically customizing an indoor space. Accordingly, the present disclosure makes specific reference thereto. Nonetheless, it is to be appreciated that aspects of the present invention are also equally applicable to other like applications, devices, and methods of manufacture.

### BACKGROUND

By way of background, individuals often enhance their personal workspace with different decorative items, such as photos, posters, plants, and other items aiming to create a more pleasant and personalized atmosphere. However, the conventional means of decoration in offices are inherently static and can be expensive. Additionally, transportation and reorganization of such items are difficult and time-consuming especially when moving to a new office space, further compounded by the risk of damage during transit.

Shared office spaces introduce additional complexities. Such office spaces are used by multiple people and can have uninspired and monotonous decor to avoid conflicts over personal tastes and preferences. Furthermore, shared spaces pose a challenge for displaying functional items such as reference charts and tools, which are essential for efficient work but may not be feasible to install in a manner that serves all users effectively. There is a need for an innovative and dynamic customization solution for indoor spaces such as office spaces that overcomes the limitations of traditional decorative and functional items.

Therefore, there exists a long-felt need in the art for a decorative system that provides dynamic customization of an office environment. Additionally, there is a long-felt need in the art for a system that provides dynamic customization of the office environment without the need for physical decorative items. Moreover, there is a long-felt need in the art for a virtual decorative system that supports various types of content, including backgrounds, backdrop images, quick reference materials, family photos, custom logos, nameplates, and welcome messages for decorating office space. Further, there is a long-felt need in the art for an improved indoor decorative system that includes a plurality of display panels associated with a software application. Also, there is a long-felt need in the art for a system that provides a software application that interfaces with digital screens installed throughout an office for the dynamic customization of the office environment. Furthermore, there is a long-felt need in the art for a system that provides dynamic customization of the office environment without the need for physical decorative items, which can be costly and cumbersome to move. Finally, there is a long-felt need in the art for a novel decoration system that leverages digital displays and a software application enabling users to dynamically decorate office space based on their profiles and preferences.

The subject matter disclosed and claimed herein, in one embodiment thereof, comprises a system for customizing office spaces through customizable digital displays. The system features an office space customization software application installed in a computing device, a docking station which functions as a connectivity hub and is connected to the computing device via a wired communication medium, a plurality of digital display panels connected to the docking station, wherein the display panels are attached to walls of the indoor space. Each panel of the plurality of display panels is configurable through the software application to display dynamic content based on user preferences and profiles stored in a cloud storage, wherein the display panels are adapted to adjust brightness automatically according to ambient lighting. The software application displays a plurality of profiles, wherein selection of a profile by an authenticated user enables selection of one or more images for display on one or more digital display panels.

In this manner, the system and associated application of the present invention accomplish all of the foregoing objectives and provide a virtual office customization system that operates on a simple software application connected to multiple digital screens installed around an office. The system enables users to create a profile on the application and plug their computer into a docking station to instantly display images onto the screens. The system eliminates static and physical customization devices and can display a background and backdrop images, quick reference screens, family photos, custom logos, nameplates, and welcome messages on a door. The system is cost-effective and can be worked in shared office spaces.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a system for enhancing personal and shared indoor spaces through customizable digital displays. The system further comprising a computing device, an office space customization software application installed in the computing device, a docking station functions as a connectivity hub and is connected to the computing device via a communication channel, a plurality of digital display panels connected to the docking station, wherein the display panels are attached to walls of the indoor space. Each panel of the plurality of display panels is configurable through the software application to display dynamic content based on user preferences and profiles stored in a cloud storage, wherein the display panels are adapted to adjust brightness automatically according to ambient lighting.

In yet another embodiment, a method for customizing indoor spaces using a dynamic workspace customization system is disclosed. The method comprising the steps of installing a software application on a computing device, connecting the computing device to a docking station via a communication channel, coupling a plurality of digital display panels to the docking station, configuring the display panels to exhibit personalized content through the software application based on user profiles and preferences of a user logged in in the application. The method also includes selecting at least one panel for scrolling of images and activating at least one panel for a specific time duration.

In another aspect, a software application designed for customization of office spaces, compatible with multiple operating systems is disclosed. The application is configured to instruct a processor of a computing device to perform user authentication to access individual profiles, store user profiles and preferences on a cloud storage, receive a selection of one or more images for display on one or more display panels, and displaying selected one or more images on one or more display panels. The software application also enables the processor to schedule the display of images at predetermined times, enabling users to automate the display of specific moods, reminders, or images based on the time of day or specific user-defined schedules.

In another embodiment, the digital display panels include touch display capabilities enabling users to interact directly with the displayed content for customization and navigation purposes, including, but not limited to, changing displayed content, adjusting settings, and accessing detailed information about displayed items.

In yet another embodiment, the communication channel between the computing device and the docking station supports both wired and wireless connections, including, but not limited to, USB, USB-C, Wi-Fi, and Bluetooth.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of the virtual indoor customization system of the present invention in accordance with the disclosed architecture;

FIG. 2 illustrates a perspective view of an indoor space with the installed dynamic workspace customization system in accordance with one embodiment of the present invention;

FIG. 3 illustrates home page user interface displayed by the customized indoor space software application in accordance with one embodiment of the present invention;

FIG. 4 illustrates a user interface displayed to a user for authentication to access the functionalities of the system in accordance with one embodiment of the present invention;

FIG. 5 illustrates another user interface displayed by the software application to a logged-in user in accordance with the disclosed architecture;

FIG. 6 illustrates an exemplary user interface displayed by the software application for selectively controlling display panels for customized display in accordance with one embodiment of the present invention;

FIG. 7 depicts an exemplary user interface provided by the software application for configuring a display panel in accordance with one embodiment of the present invention; and

FIG. 8 illustrates a perspective view showing work tasks and graphs displayed on a digital display panel using the software application in accordance with one embodiment of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a decorative system that provides dynamic customization of an office environment. Additionally, there is a long-felt need in the art for a system that provides dynamic customization of the office environment without the need for physical decorative items. Moreover, there is a long-felt need in the art for a virtual decorative system that supports various types of content, including backgrounds, backdrop images, quick reference materials, family photos, custom logos, nameplates, and welcome messages for decorating office space. Further, there is a long-felt need in the art for an improved indoor decorative system that includes a plurality of display panels associated with a software application. Also, there is a long-felt need in the art for a system that provides a software application that interfaces with digital screens installed throughout an office for the dynamic customization of the office environment. Furthermore, there is a long-felt need in the art for a system that provides dynamic customization of the office environment without the need for physical decorative items, which can be costly and cumbersome to move. Finally, there is a long-felt need in the art for a novel decoration system that leverages digital displays and a software application enabling users to dynamically decorate office space based on their profiles and preferences.

The present invention, in one exemplary embodiment, is a software application designed for customization of office spaces. The application is configured to instruct a processor of a computing device to perform user authentication to access individual profiles, store user profiles and preferences on a cloud storage, receive a selection of one or more images for display on one or more display panels, and displaying selected one or more images on one or more display panels. The software application also enables the processor to schedule the display of images at predetermined times, enabling users to automate the display of specific moods, reminders, or images based on the time of day or specific user-defined schedules.

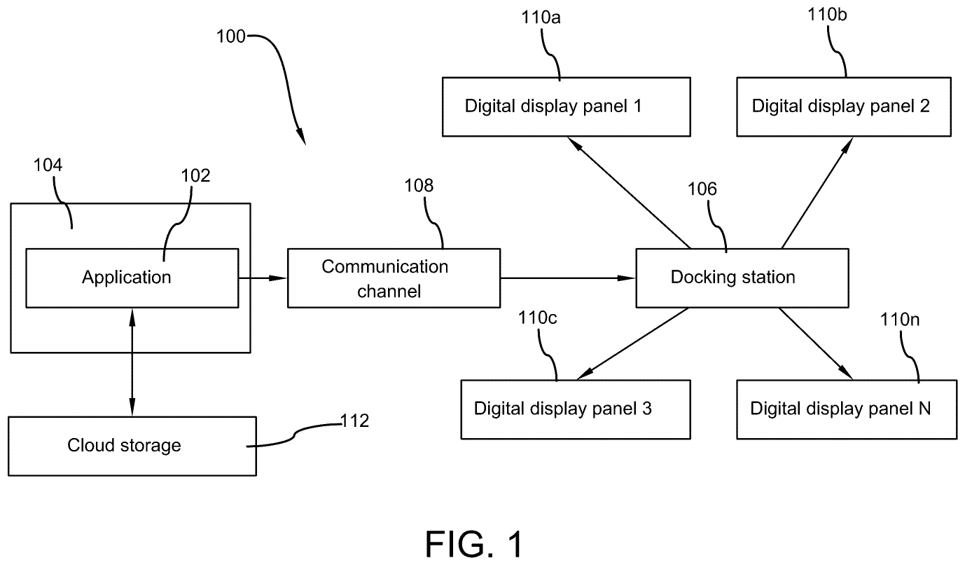

Referring initially to the drawings, FIG. 1 illustrates a schematic view of the virtual indoor customization system of the present invention in accordance with the disclosed architecture. The virtual indoor customization system 100 of the present invention is designed for enhancing personal and shared indoor spaces such as office spaces through customizable digital displays. The dynamic workspace customization system 100 is operated via an office space software application 102 installed in a computing device 104 such as a laptop or any other electronic device. The office space customization software application 102 can be compatible with different operating systems such as Windows and Mac. In some embodiments, a website can be used for accessing the functionalities offered by the office space customization system 100.

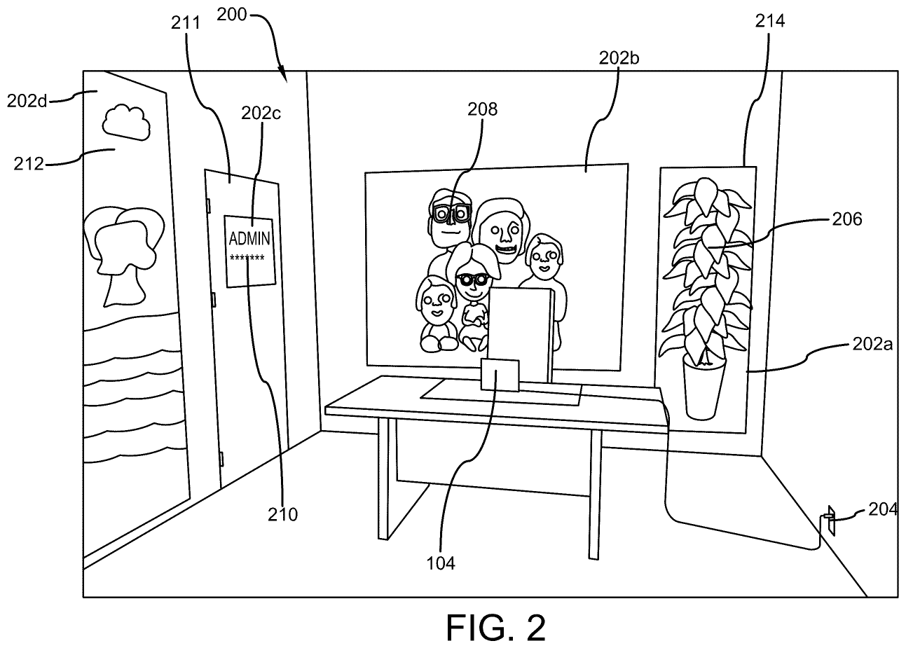

The software application 102 provides a plurality of user interfaces for enabling users to access the functionality provided by the virtual office space customization system 100. The software application 102 is connected to a docking station 106 using a communication channel 108. The docking station 106 functions as a connectivity hub and enables the application 102 to communicate with a plurality of digital display panels 110a-n. In the preferred embodiment, the digital display panels 110a-n are in the form of LCD panels that are permanently or detachably mounted on the walls of an indoor space as illustrated in FIG. 2.

The docking station 106 can be in the form of a portable device or can be integrated into a wall of the indoor space for enabling access of the display panels 110a-n to customize the indoor space. The communication channel 108 is preferably a wired channel and can be in the form of USB, USB-C, or any other type of wired channel depending on the ports available in the docking station 106. The docking station 106 preferably includes the specific software or drivers for communication with the electronic device 104 and the connected display devices 110a-n.

The application 102 enables one or more users to customize the indoor settings as per their corresponding preferences and profiles for use in a shared office space. Accordingly, the office space customization software application 102 is coupled to a cloud storage 112 wherein the cloud storage 112 stores profiles of different users who have access to the application 102 for customization of the indoor space. Each profile is associated with authentication credentials which can include a username and password for enabling secure access to the profile.

Each panel of the display panels 110a-n is preferably a touch display and can adjust display brightness automatically according to the ambient lighting of the indoor space. The display panels 110a-n can be of different sizes to fit different walls of an indoor space. The panels 110a-n preferably receive electric power from the docking station 106 and alternatively, each panel can be independently connected to an AC or DC power supply for receiving the electric power.

The application 102 can be configured to connect and control the display of display panels of one or more indoor spaces. Further, as described later in the disclosure, the display panels can be included or excluded from a profile of a user to limit the control on the display panels of specific users.

FIG. 2 illustrates a perspective view of an indoor space with the installed dynamic workspace customization system in accordance with one embodiment of the present invention. In the present embodiment, the indoor space 200 is customized using the display panels 202a, 202b, 202c, 202d (which are the same as panels 110a-n). The electronic device 104 having the installed software application 102 is connected to the docking station 106 which is a hardware device and includes port 204 for receiving the wired communication channel 108. The docking station 106 is coupled to the display panels 202a-d through a wired or wireless channel (Bluetooth).

The display panels 202a-dare independent and can be configured separately using the software application 102. As illustrated, the display panel 202a displays a tree 206 and a user can touch the tree 206 on the touch display panel 202a to enable the display panel 202a to display details of the tree 206. The display panel 202b can display an avatar or a family animation or cartoon 208 which can be selected using the office space customization software application 102 or can automatically be displayed based on the profile of the logged-in user in the office space customization software application 102.

The display 202c positioned on the door 211 can display the details 210 of the logged-in user in the application 102. The display 202c can dynamically display the details of the logged-in user indicating the person occupying the indoor space 200. The display panel 202d displays natural scenery 212 for providing a natural and customized look to the indoor space 200. Each display panel can include an adhesive on the rear surface 214 for attachment to a wall and alternatively, can be secured using mechanical fasteners.

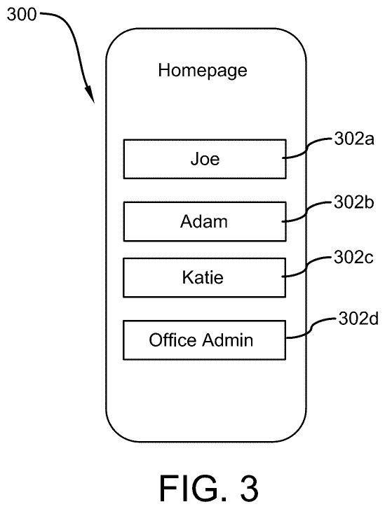

FIG. 3 illustrates home page user interface displayed by the customized indoor space software application in accordance with one embodiment of the present invention. The home page user interface 300 is preferably the first user interface displayed to a user by the application 102. The home page user interface 300 is adapted to display different profiles associated with the docking station 106 for an indoor space. In a shared space, a plurality of users can connect their own electronic devices with the docking station 106 installed in the shared space, and the application 102 in each electronic device can represent different profiles. As illustrated, the user interface 300 displays a plurality of user profiles 302a-d and the application 102 and customization system 100 are customized based on the selected profile.

It will be apparent to a person skilled in the art that a profile is accessible only to authorized users. The application 102 prompts a user to input credentials upon selection of a profile for accessing the application 102.

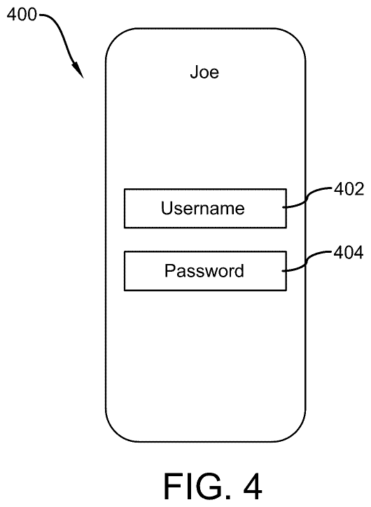

FIG. 4 illustrates a user interface displayed to a user for authentication to access the functionalities of the system 100 in accordance with one embodiment of the present invention. In the present embodiment, a profile “Joe” is selected from the user interface of FIG. 3. Then, the user interface 400 provides a username input box 402 and password input box 404 for receiving login credentials for authentication. The system 100 compares the received credentials with the stored credentials for the corresponding profile in the cloud storage 112.

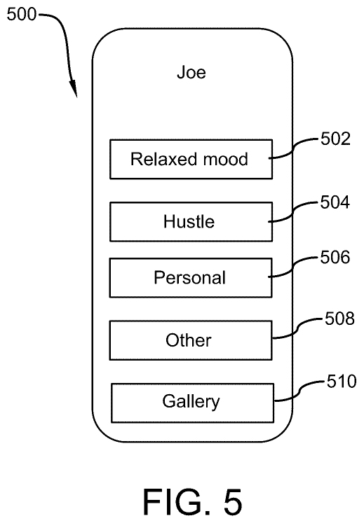

FIG. 5 illustrates another user interface displayed by the software application to a logged-in user in accordance with the disclosed architecture. In the present embodiment, the logged-in profile is “Joe”. Based on the preferences and profile of the user, different moods are displayed on the application using the interface 500. The moods can be automatically customized based on the time of the day and climate. As illustrated, the interface 500 can display “Relaxed mood” 502, “Hustle” 504, “Personal” 506, and “Other” 508 profiles. Each mood includes a plurality of images which can be selected for display on one or more display panels positioned in the office space and connected to the docking station which is wired-connected to the application.

Based on the selection of the images, the list of moods or categories can be automatically updated by the application. Also, personalized images can be accessed from the Gallery option 510 of the application 102. The application 102 enables a user to upload images for display on the display panels of the system.

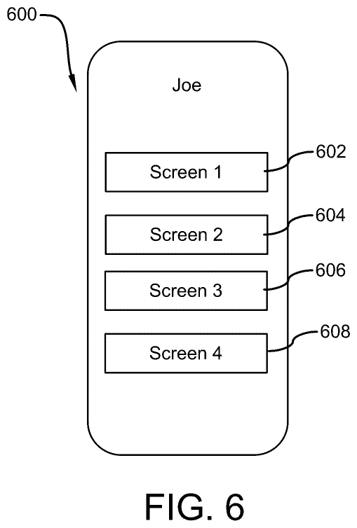

FIG. 6 illustrates an exemplary user interface displayed by the software application for selectively controlling display panels for customized display in accordance with one embodiment of the present invention. The user interface 600 displays the list of display panels associated with the docking station 106 connected to the application 102. As illustrated, the display panel icons 602-608 are displayed and a display panel icon can be selected by a user to control the image and display characteristics of the corresponding display panel. Each display panel of the system 100 can have different size display characteristics, and operate independently from the other display panels of the system 100.

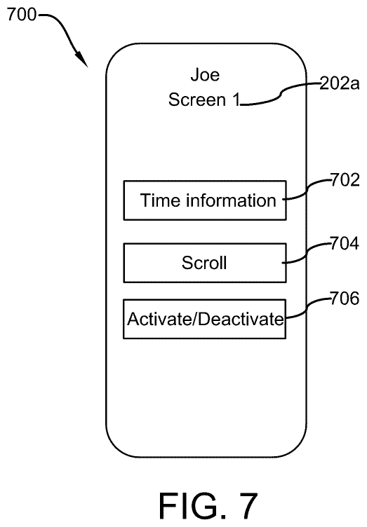

FIG. 7 depicts an exemplary user interface provided by the software application for configuring a display panel in accordance with one embodiment of the present invention. As illustrated, the user interface 700 is displaying configuration parameters for display panel 202a. The “Time information” option 702 enables a user to select a time duration such as from 7:00 PM to 8:30 PM for displaying images on the display panel 202a. The option 702 helps in saving electric power required to run the display panel 202a.

A “Scroll” option 704 enables users to select multiple images to be displayed on the screen 202a in a scrolling manner. The scrolling speed can be set when more than one image is selected for the screen. Further, in some embodiments, the scrolling speed can be set to a predetermined length of time, such as each image may be displayed for 30 seconds or any other time set by the user.

An “Activate/Deactivate” option 706 provides the manual activation of the display screen 202a. This helps users in the deactivation of specific screens such as during video conferencing calls and more.

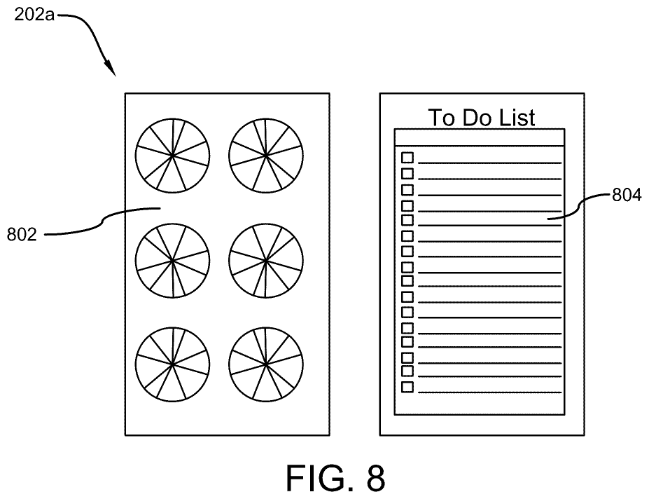

FIG. 8 illustrates work tasks and graphs displayed on a digital display panel using the software application in accordance with one embodiment of the present invention. The system 100 can be used for displaying reminders, work tools, graphs, and more on one or more digital display panels. As illustrated, the digital display panel 202a displays graphs 802 and To-Do List 804 of a user for easy accessibility. The application 106 can have access to third-party applications running in the electronic device 104 for displaying the corresponding data on one or more screens.

In one embodiment, a method for customizing indoor spaces using a dynamic workspace customization system is disclosed. The method comprising the steps of installing a software application on a computing device, connecting the computing device to a docking station via a communication channel, coupling a plurality of digital display panels to the docking station, configuring the display panels to exhibit personalized content through the software application based on user profiles and preferences of a user logged in in the application. The method also includes selecting at least one panel for scrolling of images and activating at least one panel for a specific time duration.

It will be apparent to a person skilled in the art that the system 100 enables for the dynamic customization of an office environment without the need for physical decorative items, which can be costly and cumbersome to move. Users can create personal profiles within the application and when they connect their computer or other computing device to the docking station in an office, the personalized content such as images or messages can be automatically displayed on the digital screens. The system 100 can support different types of content, including backgrounds, backdrop images, quick reference materials, family photos, custom logos, nameplates, and welcome messages. The system 100 can include different configurations for the digital displays ranging from a plurality of small screens mounted on walls to a single large screen.

Embodiments of the present disclosure take the form of computer-executable instructions, including algorithms executed by a programmable computer. However, the disclosure can be practiced with other computer system configurations as well. Certain aspects of the disclosure can be embodied in a special-purpose computer or data processor that is specifically programmed, configured, or constructed to perform one or more of the computer-executable algorithms described below. Accordingly, the term “computer” as generally used herein refers to any data processor and includes Internet appliances, hand-held devices (including tablets, computers, wearable computers, cellular or mobile phones, multi-processor systems, processor-based or programmable consumer electronics, network computers, minicomputers) and the like.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “virtual indoor customization system”, “dynamic workspace customization system”, “office space customization system”, “customization system”, and “system” are interchangeable and refer to the office space dynamic customization system 100 of the present invention.

Notwithstanding the foregoing, the office space dynamic customization system 100 of the present invention can be of any suitable size and configuration as is known in the art without affecting the overall concept of the invention, provided that it accomplishes the above-stated objectives. One of ordinary skill in the art will appreciate the office space dynamic customization system 100 as shown in the FIGS. are for illustrative purposes only, and that many other configurations of the office space dynamic customization system 100 can be included in the present invention.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A virtual indoor customization system of digital displays comprising:
a software application;
a computing device;
a plurality of digital display panels;
a plurality of user interfaces; and
a docking station;
wherein said software application providing said plurality of user interfaces for user access to a system of said plurality of digital display panels;
wherein said docking station having a communication channel for connecting to said software application and to communicate with said plurality of digital display panels;
wherein said docking station is a portable device for access to said plurality of display panels; and
further wherein said user access includes a selective setting for each one of said plurality of digital display panels.

2. The virtual indoor customization system of digital displays of claim 1, wherein said communication channel is a wired channel selected from the group consisting of a USB, and a USB-C.

3. The virtual indoor customization system of digital displays of claim 1, further comprising a cloud storage connected to said software application, wherein said cloud storage having a user profile for each said user access.

4. The virtual indoor customization system of digital displays of claim 3, wherein said user profile having credentials selected from the group consisting of a username and a password.

5. The virtual indoor customization system of digital displays of claim 1, wherein each of one of said digital display panels is a touch display panel.

6. The virtual indoor customization system of digital displays of claim 1, wherein said plurality of digital display panels are LCD panels.

7. The virtual indoor customization system of digital displays of claim 6, wherein each one of said digital display panels independently receiving electric power from a source selected from the group consisting of an AC power supply and a DC power supply.

8. The virtual indoor customization system of digital displays of claim 5, wherein each one of said digital display panels having a different display.

9. The virtual indoor customization system of digital displays of claim 3, wherein each display of said digital display panels associated with said user profile.

10. A virtual indoor customization system of digital displays comprising:
a software application;
a computing device;
a plurality of digital display panels;
a plurality of user interfaces;
a docking station; and
a cloud storage;
wherein said software application providing said plurality of user interfaces for user access to a system of said plurality of digital display panels;
wherein said docking station having a communication channel for connecting to said software application and to communicate with said plurality of digital display panels;
wherein said user access includes a selective setting for each one of said plurality of digital display panels;
wherein said cloud storage connected to said software application including a user profile for each said user access; and
further wherein each display of said digital display panels associated with said user profile.

11. The virtual indoor customization system of digital displays of claim 10, wherein said communication channel is a wired channel selected from the group consisting of a USB, and a USB-C.

12. The virtual indoor customization system of digital displays of claim 11, wherein said user profile having credentials selected from the group consisting of a username and a password.

13. The virtual indoor customization system of digital displays of claim 12, wherein each of one of said digital display panels is a touch display panel.

14. The virtual indoor customization system of digital displays of claim 13, wherein said plurality of digital display panels are LCD panels.

15. The virtual indoor customization system of digital displays of claim 14, wherein each one of said digital display panels independently receiving electric power from a source selected from the group consisting of an AC power supply and a DC power supply.

16. The virtual indoor customization system of digital displays of claim 15, wherein each one of said digital display panels having a different display.

17. The virtual indoor customization system of digital displays of claim 16, wherein said docking station is a portable device for access to said plurality of display panels.

18. A customization system of digital displays comprising:
a software application;
a plurality of electronic devices;
a plurality of digital display panels;
a plurality of user interfaces;
a docking station; and
a cloud storage;
wherein said software application providing said plurality of user interfaces for user access to a system of said plurality of digital display panels;
wherein said docking station having a communication channel for connecting to said software application to communicate with said plurality of digital display panels and said plurality of electronic devices;
wherein each one of said plurality of user interfaces having an associated one of said plurality of electronic devices;
wherein said user access includes accessing said application with said associated one of said plurality of electronic devices;
wherein said user access includes a user profile having a selective setting for each one of said plurality of digital display panels;
wherein each one of said user profile associated with each one of said plurality of electronic devices; and
further wherein each display of said digital display panels associated with said user profile.

19. The customization system of digital displays of claim 18, wherein each one of said digital display panels having a different display.

20. The customization system of digital displays of claim 19, wherein said docking station is a portable device for access to said plurality of display panels.
